(19) United States
(12) Patent Application Publication
(10) Pub. No.: US 2008/0270616 A1
(43) Pub. Date: Oct. 30, 2008

(54) SYSTEM AND METHOD FOR ELECTRONIC DOCUMENT DELIVERY

(75) Inventors: Shu-Kuang Ho, Carlisle, MA (US); G. William Agudelo, Arlington, MA (US); Xiuwei Zhao, Chelmsford, MA (US)

Correspondence Address: BANNER & WITCOFF, LTD., 28 STATE STREET, 28th FLOOR, BOSTON, MA, 02109-9601, US

(73) Assignee: Biscom, Inc., Chelmsford, MA (US)

(21) Appl. No.: 11/949,323

(22) Filed: Dec. 3, 2007

Related U.S. Application Data
(60) Provisional application No. 60/914,426, filed on Apr. 27, 2007.

(51) Int. Cl. G06F 15/16; H04L 29/06

(52) U.S. Cl. 709/228; 726/12

(57) ABSTRACT

A system and method for electronically transferring documents or any type of electronic media. Application clients may be installed on, or provided in the form of, internet connected devices. The application clients may be used without having to reconfigure a device firewall. A central server may be used to connect document transmitters to document receivers, using a global table of parties. Advantages include providing authenticated, real time, secure, reliable, and confirmed delivery among single or multiple recipients. Another feature includes a global directory to provide levels of service to users.

### RELATED APPLICATION

This application claims the benefit of U.S. provisional application No. 60/914,426 filed on Apr. 27, 2007 which is incorporated herein by reference.

### FIELD OF THE INVENTION

The invention relates generally to electronic media transmission, and more specifically, to documents delivered electronically.

### BACKGROUND OF THE INVENTION

The G3 fax industry started in late 1970s and is still being used today, due to its simplicity and ubiquity around the world. Fax over IP, T.38 protocol, a concept that uses the Internet to bridge source and destination, has gained popularity and is piquing the interest of the IT community. However, even though faxes are transmitted over IP networks rather than PSTN, there's no increase in quality and speed, over the regular fax standards. The following is a list of shortcomings of present day faxing technology, and issues when using fax for document delivery:
Poor quality, due to sampling distortion, or low resolution during document scanning, and phone line noise, decrease quality of document and the efficiency of OCR (optical character recognition) in work flow applications and other applications.
In today's Internet-enabled world, the near instantaneous delivery of electronic messages sharply contrasts with the lengthy time required to send and receive fax document. The Internet infrastructure should be leveraged to make fax as fast as other electronic delivery technologies.
Each fax machine and telephone number is bound to a physical location.
Faxes are primarily black and white, and color-capable fax machines are practically non-existent.

Moreover, the Internet has spawned a new form of communication which is known as electronic mail (Email). Email is a very easy and convenient way for parties to communicate in an informal manner. However, it has its limitations, specifically it does not provide for real-time delivery of messages, confirmed delivery of a messages (supported in some cases but not universal), and standard secure transport for confidential communication.

### BRIEF SUMMARY OF THE INVENTION

The present invention includes a system and method for delivery of documents in electronic form. An embodiment of the present invention provides real-time, secure, reliable and confirmed delivery of documents. The documents are delivered with increased speed and quality.

Users of one embodiment of the present invention use a Central Office that contains a directory of other users. When one user wishes to deliver a set of documents to another user, the communication and addressing is handled through the Central Office. Alternatively, an embodiment allows direct connect mode that allows devices to directly communicate with other devices without going through a Central Office.

Various embodiments use a packet switched network rather than a circuit switched network such as a phone system. Devices according to this embodiment can be plugged into any Internet-accessible network anywhere in the world and send and receive documents.

An embodiment of the present invention includes a method of transmitting information, including establishing a connection to a central office or server using a secure socket connection; providing to the central server an indication of a recipient address; transmitting the information over the established connection to the central server, wherein the central server transmits the information to the recipient over a connection established by the recipient to the central server using a secure socket connection. The connection may be established through a local firewall.

In one embodiment, the central server may perform authentication before the central server establishes the connection. Further, the connection from the recipient to the central server may be established before the step of providing to the central server an indication of a recipient address. Alternatively, the recipient may establish the connection to the central server in response to a message transmitted by the central server to the recipient.

The central server may include a directory of recipients, and the central server may select a recipient based on the indication of a recipient address. An embodiment may include providing to the central server an indication of a recipient address includes utilizing a directory of recipient addresses maintained by the central server. The directory may include an indication for a recipient what document or information formats are supported for transmitting information to the recipient. Further, the step of transmitting the information over the established connection to the central server includes receiving permission to transmit the information in a format indicated by the directory as supported for a recipient, wherein the information format was not previously available.

An embodiment of the present invention includes a computer readable storage medium including computer readable instructions that when executed by a processor, cause the processor to establish a connection to a central office or server using a secure socket connection; transmit an indication of a recipient address to the central server; transmit data over the established connection to the central server, wherein the central server will forward the data to a recipient identified by the recipient address over a connection established by the recipient to the central server through a secure socket connection.

Another embodiment includes a method of connecting parties for allowing the transmission of information between the parties, which includes receiving a request to connect from a first party; authenticating the first party, and accepting a data connection initiated by the first party using a secure socket connection of the first party; receiving a request to connect from a second party; and authenticating the second party, and accepting a data connection initiated the second party using a secure socket connection of the second party. It further may include receiving an indication from the first party to connect to the second party; receiving information from the first party over the data connection with the first party, and transmitting the received information to the second party over the data connection with the second party. Further, the method may include providing a directory of recipients for use by the first party to assist the first party in indicating the second party to connect to.

Advantages of the present invention include no image resolution limit, thus improving accuracy in OCR applications. Color documents may be sent and received with high image resolution, and without any size or dimension restriction. Further, documents can be sent and received in real time over secure and encrypted channels. The system and method can be used as a single user as well as an enterprise for multiple users.

Another advantage of the present invention includes a document transmission and receiving application that is easy to install on an internet connected device, such as a computer. No special configuration of a firewall utility on the internet connected device is required for the application to run.

Yet another advantage of the present invention is a global directory, which helps provide information on recipients, as well as providing different levels of capabilities to users and clients. A user may have standard capabilities, and/or may also have enhanced capabilities such as different supported document formats or services.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrate a block diagram of an illustrative embodiment of the present invention;

FIG. 2 illustrates a network configuration of an embodiment;

FIG. 3 is a flow chart of steps performed by an embodiment;

FIG. 4 illustrates an embodiment of the present invention for enterprise use; and

FIG. 5 shows a screen presentation from a client application according to an embodiment.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

The present invention comprises a novel system and method for sending and receiving electronic documents and images. Although described in terms similar to facsimile process, the present invention provides capabilities far beyond what is possible by facsimile machines. The present invention may transmit, forward and route any type of electronic media, including categories such as audio, video, multimedia or other media, application-specific files, and data. Further examples include cad/cam, x-rays and other medical images, architectural drawings, spreadsheets, databases, etc.

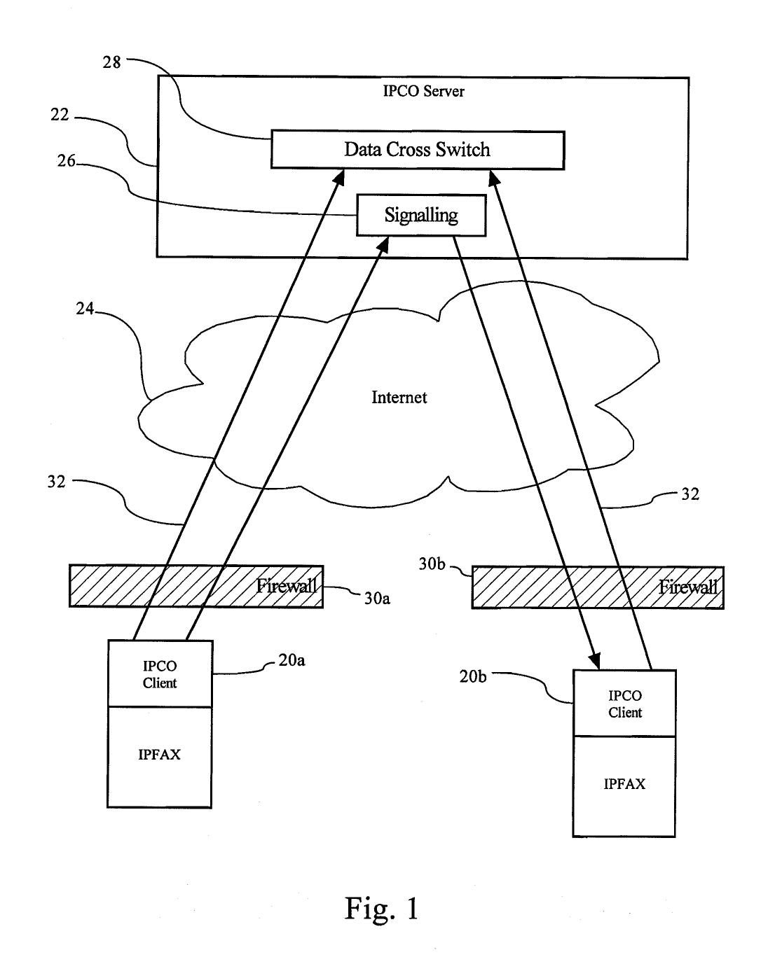

An illustrative embodiment is shown in FIG. 1. A user wishing to send a document may use an application referred to as an IPCO (IP Central Office) client application 20a to scan in the document, and then connect to an IPCO server 22 over the internet 24 or other electronic communication path. Any form of document or media may be transmitted, including for example files already stored on the system, or provided on media, images, audio or video files, etc. The IPCO server 22 maintains a directory of possible recipients, and selects the proper recipient for the document. The IPCO server 22 also may act as a switch 28 to connect the sender to the recipient, so the recipient can receive the electronic documents by its IPCO client application 20b.

An advantage of the illustrative embodiment is that each IPCO client application 20 can be protected by a local firewall 30 (or other such protection mechanism) from the internet 24 or other such data transmission medium. The firewall 30 does not need to be configured to allow incoming outside connections. This is because the embodiment works by having each IPCO client application 20 initiate establishing a link outbound through its firewall (as shown by arrows 32), a process that most firewalls can allow without modification. In this embodiment, each IPCO client application 20 establishes a secure link 32 using an SSL (secure sockets layer) socket, and connects to the IPCO server 22 using the secure outbound connection. The IPCO server 22 maintains the connections, and connects various client applications 28 as necessary to allow the electronic documents to be sent and received. If a connection 32 is dropped, the connections may be re-established when the IPCO client application 20 attempts to re-connect to the IPCO server 22. An embodiment may connect through a standard socket or sockets, such as socket 80 or 443, or alternatively through any available open socket. A description of the communication signaling is provided below.

The IPCO server 22 eases the burden for installers and end-users by facilitating the connection and accessibility of client applications over the internet 24 without regards to how such application or device is connected to the internet 24 and permits plug and play connectivity. In other words, there is no need to request a static IP address or to reprogram the router/firewall 30. A device according to one embodiment may be provided with a unique identifier (typically assigned by the IPCO Server 22), which will be used as a Global Unique Identifier so that other devices can directly connect to it. Although described in terms of IP Fax devices, the same service can be extended to other type of devices such as MFPs (multi-function peripherals) and video servers.

A service provided by an embodiment is referred to as an IPCO Service, and is composed of the IPCO Server 22, FIG. 1, which is installed as servers on the internet 24 and a multitude of IPCO clients 30 which are the point of access to the IPCO Service.

Each device that wants to use the IPCO Service for connectivity can use the IPCO Client 20 in order to access the functionality of the IPCO Service. The IPCO client implements authentication, secure communication via SSL, presence, call signaling and data transfer on behalf of the device. It does this in coordination with the IPCO Server 22. The IPCO Client 20 may be implemented as an ActiveX control for Windows Connected clients, or it could be provided as an embedded client into a device such as an MFP. Data may be transmitted in any format, including TCP or UDP protocols, or other protocols.

The IPCO server 22 acts as a central exchange and keeps a master list of registered devices. It may provide secure encrypted communication via SSL, and connection management between devices by providing an orderly set up of data connections between devices. It may also provide bandwidth management, and billing. Support for multiple concurrent send/receive connections per device may be provided.

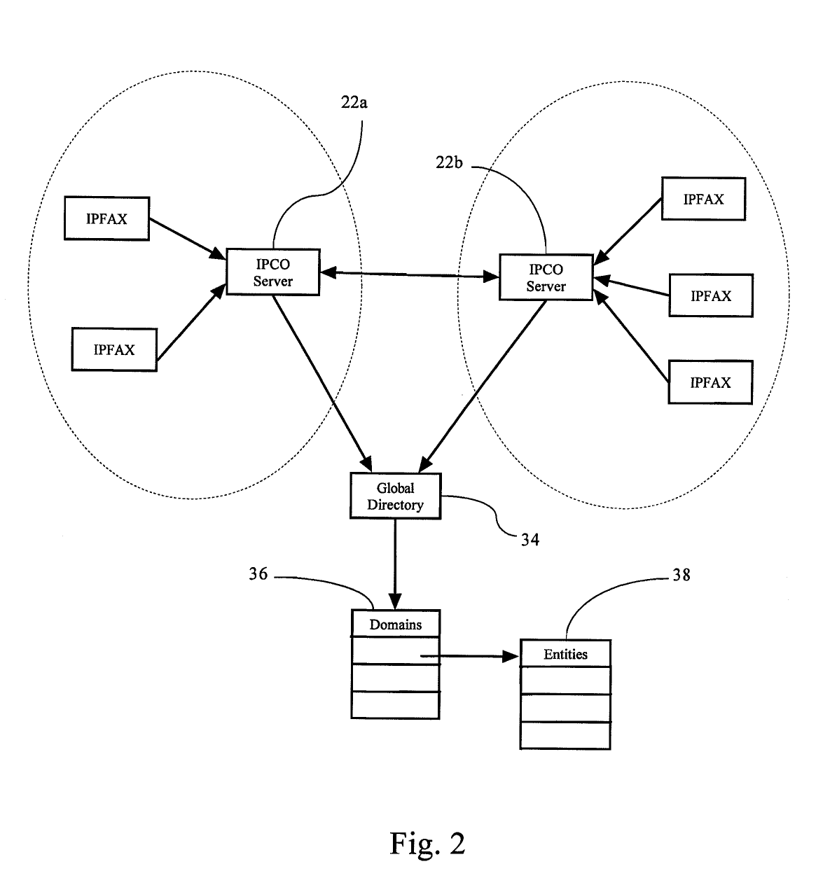

FIG. 2 shows a configuration using multiple IPCO servers 22 serving different or related entities. An IPCO server 22 may also access a local/remote application used to access the Global User Identifier list which serves as a global directory 34 of entities which are registered with the service. The global directory 34 may contain access rights and authentication information for each valid account. One or more web-servers may be provided to allow users or administrators to create new user accounts in this global directory 34, with the appropriate validation and if required, billing information. Moreover, provisions are made to allow one or more IPCO servers 22 to be meshed together in a way that its corresponding users can inter-communicate.

An advantage of an embodiment with a global directory is that all applications using the IPCO server 22 must be registered and authenticated. This may help prevent unregistered users, “spoofers” and other parties from sending unrequested or unauthorized transmissions. Any use of this embodiment allows verification of who transmitted the material or information.

The global directory 34 may also include information about each account, including enhanced capabilities for certain accounts. In one embodiment, there is a standard set of capabilities for each account, but accounts may be given enhanced capabilities (for example, different types of documents or media, or other services). These enhanced capabilities may be presented or advertised through the global directory 34. These enhancements may be added on the fly, as an account is located in the global directory 34. For example, when a user request an account listed in the global directory, any enhancements that account may have can activate different or enhanced services to that account.

A global unique name may be assigned to each entity that utilizes the IPCO Service. In one embodiment, a global unique name comprises three parts separated by a delimiter such as “.”. As one example, this would be a <local name>.<service keyword>.<domain name>. In one embodiment, the service keyword “.ipfax” is reserved in the name space, to indicate multimedia electronic document exchange capabilities, however a different keyword or keywords may be used. Typically a service keyword can only occur once in a name and is utilized as a meta-tag. Additional categories of services may be provided which use a different service keyword, for example a video exchange service may use “ipvideo” service keyword. Such services may be hierarchical. If the keyword is present, the name to the left of this keyword typically is the entity local name. The part of the name to the right of the service keyword is typically the entity domain name (ipfax inclusive). Each entity name within a domain can be unique.

In some cases, the keyword may be omitted, for example, in local domain context usage (such as within the IPCO server 22 domain space). The part of the keyword to the right of the name is the IPCO Server domain name (ipfax inclusive). Each entity name within a domain is required to be unique.

An example global unique identifier would be “mailroom.ipfax.sales.biscom”. In this example, mailroom is the entity local name, and ipfax.sales.biscom is its corresponding entity domain name.

The global directory 34 may be used to define one or more IPCO server domains 36. Each domain may contain a corresponding list of entities 38 and their associated account profiles. The account profile defines the service type that the entity supports (for example, ipfax etc.), permissions, password information, and advertised enhanced capabilities, as well as utilization parameters assigned to an entity. Advertised enhanced capabilities are additional capabilities (beyond the standard capabilities) that the entity supports for a specific service category (for example, an ipfax entity could support not only jpeg and tiff images, but it could also advertise that it is able to support receipt of CAD/CAM images)

Typically each entity has a “home” domain which it uses as a point of entry into the system.

The global directory 34 may be implemented in various manners depending on the scope and scale of deployment. On a small scale, the global directory 34 may co-reside on a single IPCO server 22, where only a few dozen entities are inter-communicating with each other. In a world-wide carrier type deployment, the global directory 34 may be implemented in a distributed manner separate from the IPCO Servers 34. Other embodiments are also possible, including multiple global directories 34 providing different services (or categories of services) to various client bases, or multiple global directories 34 providing a same service with redundancy for speed or fail-safe operation. Other such arrangements such as a hierarchy of global directories 34 may also be utilized.

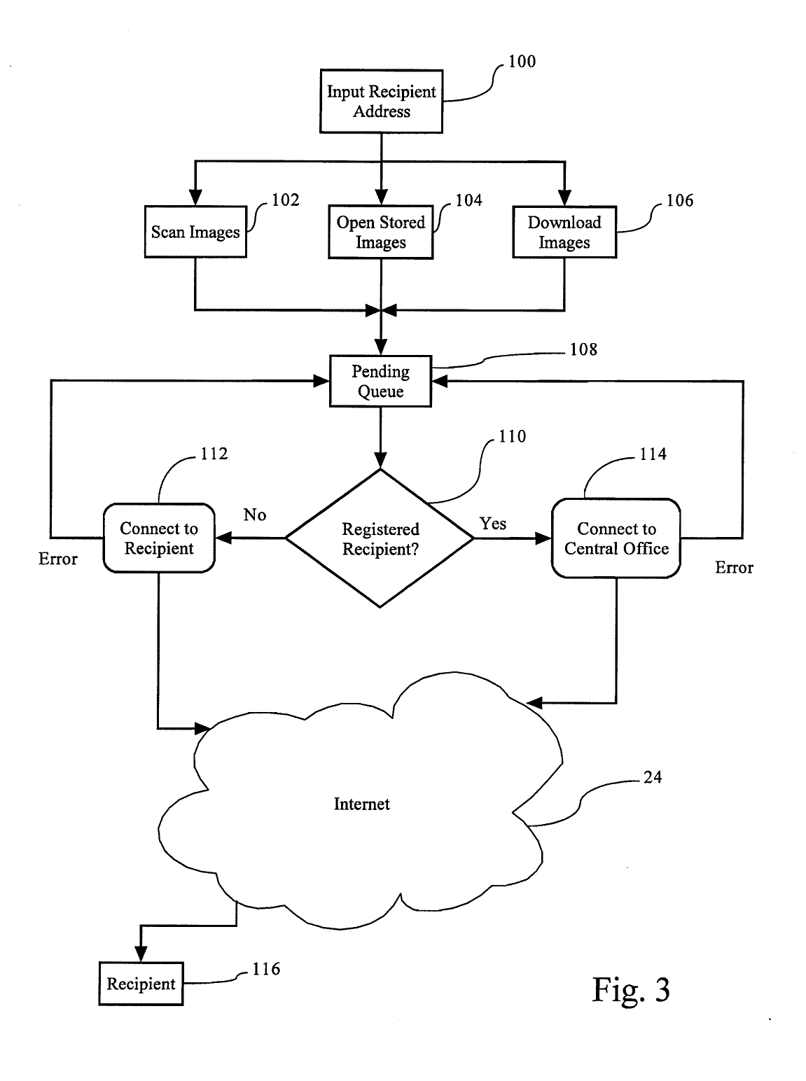

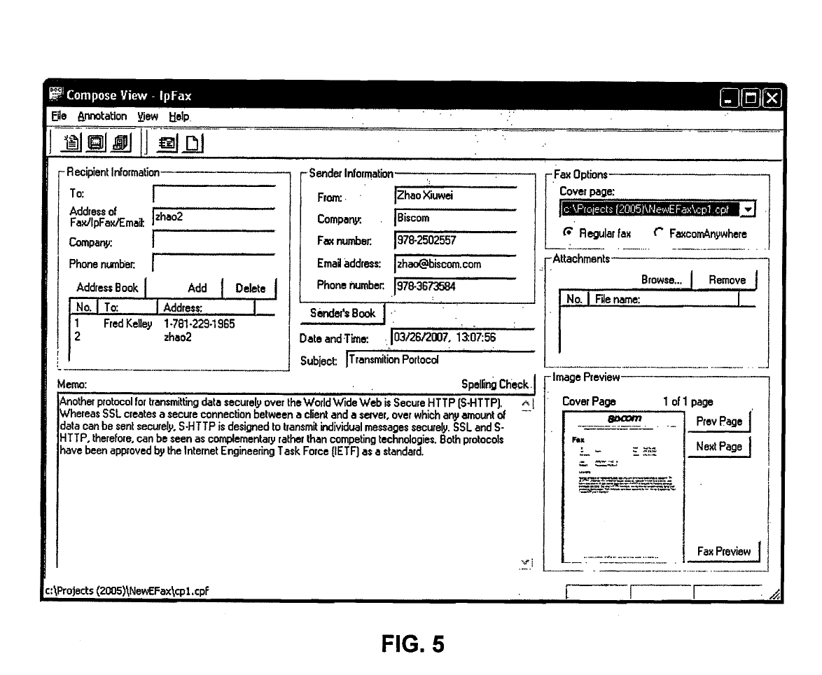

FIG. 3 shows steps taken by an embodiment of the present invention for sending and receiving electronic documents. A user with a document to send will select the recipient, step 100. This may be entered in any manner, including the example input user interface shown in FIG. 5. As an example, a recipient may be selected from an “address book”, or from a list of previously entered recipients. One or more global directories may be searched or queried to identify recipients.

Next, the document is selected for transmission. The document may be entered in any manner, including scanning 102, selecting a stored data file 104, or obtaining the document in any other manner, such as downloading 106. For documents being scanned in 102, any scanning device may be utilized, and any graphic file format may be supported, including JPEG, PDF, postscript, encapsulated postscript, GIF, etc. For stored or downloaded files 104, 106 any format may be used, including any file format such as a music or sound files, text document, spreadsheet, rich text document, and markup language documents as well as graphics file formats. An important feature is that the present invention is not just useful for fax and image transmission, but also for secure transmission of any kind of electronic data.

Once the documents or images are ready, the job is submitted to a transmission queue, step 108. Typically the transmission queue is on the local machine; however it may be at other locations.

When the job is processed, different paths to the recipient are possible. If the recipient 116 is registered in the central office, the transmission can flow through the central office 144, with the central office working to connect the sender to the recipient, as shown in FIG. 1. The sender does not need to know the recipient's true IP address or other details, since the central office maintains the records and completes the connection.

Alternatively, a user may send an IP Fax directly to a recipient 116 using the internet 24, step 112, without going through the central office. This can be used for different situations, for example if a recipient is not registered at the central office, or if a recipient is not behind a firewall. If a user selects not to go through the central office, the user can input a real IP address of the recipient and the embodiment uses a protocol such as TCP/IP to connect to the recipient.

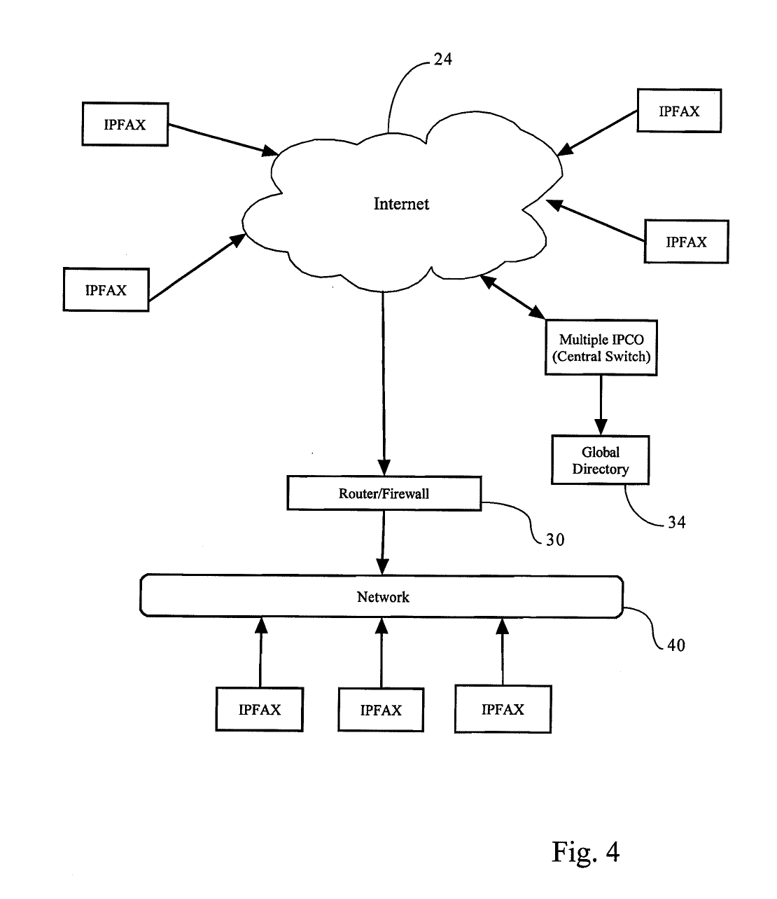

FIG. 4 shows a configuration for an enterprise-wide embodiment, with multiple IP Fax clients connected to a network 40 that connects through a firewall 30 to the internet 24.

FIG. 5 shows a screen presentation of an IPCO application client according to one embodiment. The IPCO application client can run on any computer platform, other device with internet access, or as a stand-alone device. FIG. 5 shows a compose view, that allows users to perform steps including entering recipient and sender information, typing in messages, setting attachment files, and selecting a cover page. The user can send the electronic document out as an ipfax, a regular fax or an email, depending on what they enter in the recipient address box. The IPCO application client will recognize the address type and automatically choose a corresponding method to send it.

Users can enter an address, or open an address book dialog (not shown). Users can add addresses by typing in Name, Address, Company and Phone number then clicking the Add button one by one, and can select one or multiple addresses from the list then click OK button to set them into the recipient list on the Compose View. When the user types in new recipient information on the Compose View and then clicks the Send button, the new recipient information will be automatically saved in the Address book.

There is also an Image Preview on Compose View. When users select a cover page, or set some attachment files which are image files, they can view these images on the preview box by selecting the file item in the list. When the selection is a cover page, all information typed in so far on the Compose View, will be automatically merged into the cover page and appear in the preview image.

There is also an image viewer (not shown) which includes the following functionality:

1) Scan images: Using any type of image scanner, users can scan documents or any other material, and the images will appear on the screen therefore can be used as attachments of the ipfax, fax or email. Other types of image capture are possible; including a print option that presents users with a printer choice that when selected will convert the document into a selected image format for transmission.
2) Organize attachments: Opening image files and/or scanning images, then selecting some pages (by right clicking on the pages) from them, users can make an attachment by clicking Make Attachment button, and it will be inserted into the attachment list on Compose View automatically.
3) View the images: When the user receives ipfaxes and faxes, they will appear in the list in Admin View. Double clicking the item in the list, the screen will be automatically switched to Image View and the images will appear on the screen.
4) Fax preview: When the user composed a fax in Compose View, clicking Fax Preview button, the screen will be switched to Image View, and they can preview the fax images.

The IPCO application client may also include administrative functionality (not shown) which includes:

1) Current Job: This shows the job progress. If an error occurs, the error message will appear. When the current job is a regular fax, the user can click Stop Sending button to abort the sending.
2) Pending Queue: This shows all jobs waiting to be sent out. Users can create multiple jobs and the jobs may take a long time to be sent out one by one. The jobs which have not yet been sent will appear in this view in a certain order. If a job fails to be sent, this job may be sent to the back to the bottom of the list to wait for a later time to be sent out. Selecting an item in the job list and click Remove button will remove this job from the list.
3) Received Faxes: This shows all received faxes and ipfaxes. The file name extension “ip” means this file is an ipfax. Extension “fax” means the file is a fax. Clicking on an item in this list will display the first page the document. Because the first page is usually the cover page, users can decide if it is necessary to move it to some folder in the local machine or the network by clicking “Move to . . . ” button, or to delete it by clicking Remove button.
4) Sent Log: This shows the information of all jobs have been sent out so far. Following is its screen:

The IPCO Client ActiveX Control Interface will now be described. The ActiveX Control is called by the IPFax application in order to access the functionality of the IPCO Service. This is meant to be a high level interface which hides the details and complexity of the low level protocol described below in the Section IPCO Service Low Level Protocol. More details on the IPFax application will be provided below.

Typically a minimum of four parameters are used to communicate with the IPCO Service: IPCO Server IP Address, IPCO Server IP Port, Global User ID Name (a valid pre-registered account ID), and the corresponding Global User ID Password.

An application according to one embodiment will call the ActiveX control in the following manner:

1. First it will instantiate the control.
2. Set properties: Service IP Address, Service IP Port, Global User Identifier (assigned by IPCO Service), Password.
3. Logon to IPCO Server, by calling Login function.
4. Read Service Permission Properties parameters (based on type of license):
1. Allowed Mode, (Send or/and Receive)
2. Max No. of Concurrent Send/Receive calls allowed.
3. Max Size of IO buffer for read/writes
4. Max Allowed Bandwidth usage per call.
   5. The application reads the Service Permission Properties above, and selects the modes accordingly, as follows:

If Receive Mode is allowed by the service and supported by the application, and the application wants to prepare to handle incoming calls, it will instantiate a new thread for each concurrent incoming call that needs to be handled.

### 1. Instantiate ActiveX Control.

2. Set properties: Service IP Address, Service IP Port, Global User Identifier (assigned by IPCO Service), Password.
3. Logon to IPCO Server, by calling Login function.
4. If successful, Call AnswerCall function to prepare to receive a call.
5. AnswerCall will return when an incoming call is answered
6. GetCallerID property can be called to determine who the caller is.
7. If application wants to abort the call, call Logout function
8. If the application wants to accept call, call Receive and Send functions to begin exchanging data.
9. The receive function will indicate when the call has been dropped. It will also indicate if the call ended normally and all the data was safely exchanged.

If Send Mode is allowed by the service and supported by the application, and the application wants to prepare to handle outbound calls, then it will instantiate a new thread or process for each concurrent outbound call that needs to be handled.

### 1. Instantiate Control.

2. Set properties: Service IP Address, Service IP Port, Global User Identifier (assigned by IPCO Service), Password.
3. Logon to IPCO Server, by calling Login function.
4. Invoke Call function to initiate an outbound call. The Global User ID Name of the destination is passed as a parameter. The call will return with call connect success/failed indication. I.e. Connected, Busy, Not available, etc . . .
5. If call connect is successful, the Send/Receive functions can be called to exchange data with the remote end.
6. When the caller has completed the transfer of data, it will prepare for the graceful termination of the call by first passing Call Record information (used for audit or billing purposes) such as Date/Time of transmission, No. of pages sent, Sender Name, Recipient Name, Status, Billing ID. The IPCO server 22 will also add to the call record the following: Sender Device Global User ID Name, Recipient Device Global User ID Name, and total No. of bytes sent/received.
7. After the Call Record information has been provided, the application will call the CallEnd function to terminate the call. The CallEnd function will return an end of call status indicating the end of call outcome.
8. If the application wants to make another call, then it can invoke the Call function again, otherwise, it can invoke the Logout function to disconnect from the service.

The following Table 1 sets for the low level protocol according to one embodiment.

| | Channel/ | | Channel/ | |
|---|---|---|---|---|
| Calling Entity | Direction | IPCO Server | Direction | Called Entity |
| Request | Signal | | Signal | Request Authentication |
| Authentication | → | | ← | |
| | | Server Assign Session Token | | |
| | | if authenticated | | |
| Response | Signal | Server returns assigned | Signal | Response |
| Authentication | ← | Unique Session Token and | → | Authentication |
| Successful | | License Parameters with | | Successful |
| | | Response | | |
| Establish Data | Signal | | Signal | Establish Data |
| End Point | → | | ← | End Point |
| Request | | | | Request |
| | Signal | | Signal | |
| Data End Point | Data | | Data | Data End Point |
| established | | | | Established |
| | | | Signal | Request Ready |
| | | | ← | to Accept |
| | | | | Calls |
| | | if entity allowed to accept | Signal | Response successful |
| | | calls, response successful | → | |
| | | Entity is ready to accept calls | Signal | Request Accept a |
| | | | ← | Call (blocks until |
| | | | | incoming call arrives) |
| Request to make | Signal | Check if called entity is | | |
| a Call to an | → | Available (on same or | | |
| Entity | | different IPCO Server) | | |
| Query for Entity | Signal | Issue Locate (LOC) command | Signal | Respond with Entity |
| Location | → | To get Entity IPCO Server | ← | IPCO Server Location. |
| | | Location. | | |
| | | If Entity is on same IPCO | | |
| | | server, then proceed to | | |
| | | request connection. If not, | | |
| | | must first authenticate into | | |
| | | the specified IPCO server as | | |
| | | a Guest in order to request | | |
| | | connection. | | |
| | | (Called entity is available, | | |
| | | proceed to connect together | | |
| | | Caller and Called entities) | | |
| | | Server connects Data End | | |
| | | Points to establish data | | |
| | | path between entities | | |
| | | Server adds connection to | | |
| | | Active Connection List | | |
| | | Incoming call Indication | Signal | Incoming call |
| | | sent to Called entity | → | indication |
| | | | | from entity XXXX |
| Response Call | Signal | Incoming call accepted | Signal | Acknowledge |
| Connected | ← | | ← | call acceptance with |
| successful | | | | Incoming Call |
| | | | | Accept response |
| | | | | (optionally, a call |
| | | | | reject response can |
| | | | | choose to reject |
| | | | | the call) |
| | | (A data path exists between | | |
| | | Calling and Called entities) | | |
| Request Send Data | Data | → Data flows across → | Data | Request Receive |
| (multiple requests) | → | | → | Data |
| | | | | (multiple requests) |
| Request Receive | Data | ← Data flows across ← | Data | Request Send Data |
| Data | ← | | ← | (multiple requests) |
| (multiple requests) | | | | |
| (All data has been | | | | |
| sent) | | | | |
| (Now proceed to | | | | |
| end | | | | |
| connection) | | | | |
| Request End of | Signal | Calling Entity Request End | Signal | Incoming Call Drop |
| Call (passes end | → | of call, notify Called Entity | → | Indication |
| of call record) | | that call is terminating | | |
| | | Server records call record | | |
| | | information | | |
| | | for audit trail/billing | | |
| End of Call | Signal | Received Call Drop | Signal | Acknowledge |
| Acknowledgement | ← | Acknowledgement | ← | Call Drop request |
| Data End Point | Signal | | Signal | Data End |
| dropped | → | | ← | Point dropped |
| | Data | (Data path terminated) | Data | |
| | | Server deletes connection | | |
| | | From Active Connection | | |
| | | List | | |
| Request Logout | Signal | Process Logout request, | | Call Ended |
| | → | Invalidate Session Token | | |
| Response to | Signal | Respond logout successful | | |
| Logout Request | ← | | | |
| | | | | Get ready for |
| | | | | next incoming call |
| Call Ended | | | Signal | Establish Data |
| | | | ← | End Point Request |
| | | | Signal | Request Ready |
| | | | ← | to Accept Calls |
| | | Response successful, if | Signal | Response |
| | | Entity allowed to accept calls | → | Successful |
| | | Entity is ready to accept calls | Signal | Request Accept |
| | | | ← | a Call (blocks until |
| | | | | next incoming call) |

The following Tables 2 and 3 set forth the IPCO signaling formats according to one embodiment.

Signaling Channel Requests:

| Description | Command | Source | Explanation |
|---|---|---|---|
| Client | AUTH | Client | Log on into Server. Specify |
| Authenticate | ID_NAME | | ID and Password. |
| | ID_PASSW | | A session Token is issued |
| | | | if successful (SESS_TK). |
| Client Un- | UNAUTH | Client | Log-off from Server. |
| Authenticate | SESS_TK | | Invalidate session Token. |
| Call Connect | CCR | Client | Request Call to ID_Name |
| Request | ID_NAME | | |
| Call | CDR | Client | Request to disconnect call |
| Disconnect | | | |
| Request | | | |
| Incoming | ICAR | Client | Ready to accept calls |
| Call Ready | | | |
| Incoming Call | ICI | Server | Incoming call from ID |
| Indication | ID_NAME | | Name |
| Incoming | ICA | Client | Accept incoming call |
| Call Accept | | | |
| Incoming | ICR | Client | Reject incoming call |
| Call Reject | | | |
| Incoming | ICD | Server | Drop active incoming call |
| Call Drop | | | |
| Data End | DEC | Client | Connect data endpoint |
| Point Connect | | | |
| Locate Entity | LOC | Client | Used to globally locate |
| | | | entities. Used to support |
| | | | Inter-IPCO communication. |
| Authenticate | AUTH_GUEST | Client | Used to support |
| Guest | | | Inter-IPCO communication |
| Incoming | IPA | Client | Response to Ping Request |
| Ping Accept | | | by IPCO Server. Checks |
| | | | health of connection. |

Signaling Channel Responses

| Description | Code |
|---|---|
| Request Accepted | 0 |
| Not Authenticated | 1 |
| Missing Parameters | 2 |
| Bad Syntax | 3 |
| Not Allowed | 4 |
| Internal Error | 5 |
| Disabled | 6 |
| End Point Connection Error | 7 |
| No current connection | 8 |
| Failed connection to server | 9 |
| Failed Authentication | 10 |
| Server Congestion | 11 |
| Server Disabled | 12 |
| Service Disabled | 13 |
| Connected To Destination | 100 |
| Destination Unknown | 101 |
| Destination not online | 102 |
| Destination Busy | 103 |
| Destination no answer | 104 |
| Destination refused connection | 105 |
| Destination Disabled | 106 |
| Destination not ready | 107 |
| Connection to Destination not | 108 |
| allowed | |
| Incoming call indication | 200 |
| Incoming call Dropped | 201 |
| Indication | |
| No data endpoint for source | 300 |
| No data endpoint for destination | 301 |
| Incoming Ping Indication | 400 |

The following Table 4 sets forth the Entity End of Call Record (as typically specified by calling entity).

| Description | Explanation |
|---|---|
| Date/Time | Date/Time of call |
| Recipient Name | Specified recipient name |
| Sender Name | Specified Sender name |
| No. of Pages | Total pages sent |
| Status | Success/Failure indication |
| BillBack ID | Bill back information |

The following Table 5 set forth the Server Call Record (combines End of Call Record and additional info).

| Description | Explanation |
|---|---|
| Caller Global Unique ID | Calling entity |
| Called Global Unique ID | Called entity |
| Total Bytes Sent | Total bytes sent by calling entity |
| Total Bytes Received | Total bytes received by calling |
| | entity |
| Date/Time | Date/Time of call |
| Recipient Name | Specified recipient name |
| Sender Name | Specified Sender name |
| No. of Pages | Total pages sent |
| Status | Success/Failure indication |
| BillBack ID | Bill back information |

All commands and responses are preceded by a message prolog which indicates the size of command/response data block. It has the following format:

$MSG_SIZE nnnn$
where nnnn is the size of the command/response block in bytes.

An example of a command format (encoded in XML format) is:

<REQ>

| | |
|---|---|
| <DEV_ID>1234556</DEV_ID> | <!--User Serial Number as |
| | Device ID -> |

| | |
|---|---|
| <SIG>39434343434</SIG> | <!--Application generates unique stamp |
| | signature for this command, |
| | which is returned with response -> |

```
      <CMD>AUTH</CMD>
    <ID_NAME></ID_NAME>
    <ID_PASSW></ID_PASSW>
    <SESS_TK>3445454mgelelkff</SESS_TK> (40 characters long)
    <!- session token always provided except on new logon request ->
</REQ>
```

An example of a response format (encoded in XML format) is:

```
<RSP>
    <CODE>0</CODE> <!-0 == Request accepted ->
    <DEV_ID>1234556</DEV_ID>
    <SIG>39434343434</SIG>
    <API_REV>1.0.0</API_REV>
    <SESS_TK>3445454mgelelkff</SESS_TK>
    <!- session token only provided on successful logon ->
</RSP>
```

Another embodiment includes a software development kit (SDK) that can integrate with many host systems. For example, an application program interface may be provided to allow other application to exchange documents and other media through a central office, this application program interface may be integrated or presented as a plug-in to such applications.

Another embodiment supports the T.30 protocol for backward compatibility with regular fax machines.

The inventive methods may be embodied as computer readable instructions stored on a computer readable medium such as a floppy disk, CD-ROM, removable storage device, hard disk, system memory, or other data storage medium. More or fewer software modules may alternatively be used. Each component may be an executable program, a data link library, a configuration file, a database, a graphical image, a binary data file, a text data file, an object file, a source code file, or the like. When one or more computer processors execute one or more of the software modules, the software modules interact to cause one or more computer systems to perform according to the teachings of the present invention.

One or more aspects of the invention may be embodied in computer-usable data and computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of transmitting information, comprising:
establishing a connection to a central server using a secure socket connection;
providing to the central server an indication of a recipient address;
transmitting the information over the established connection to the central server, wherein the central server transmits the information to the recipient over a connection established by the recipient to the central server using a secure socket connection.

2. The method of claim 1 wherein the central server includes a directory of recipients, and the central server selects a recipient based on the indication of a recipient address.

3. The method of claim 1 wherein the connection from the recipient to the central server was established before the step of providing to the central server an indication of a recipient address.

4. The method of claim 1 wherein the recipient establishes the connection to the central server in response to a message transmitted by the central server to the recipient.

5. The method of claim 1 wherein the step of establishing a connection to a central server includes establishing a connection through a local firewall.

6. The method of claim 1 wherein the step of establishing a connection to a central server includes the central server performing authentication before the central server establishes the connection.

7. The method of claim 1 wherein the step of providing to the central server an indication of a recipient address includes utilizing a directory of recipient addresses maintained by the central server.

8. The method of claim 7 wherein the directory includes an indication for a recipient of information formats supported for transmitting information to the recipient.

9. The method of claim 8 wherein the step of transmitting the information over the established connection to the central server includes receiving permission to transmit the information in a format indicated by the directory as supported for a recipient, wherein the information format was not previously available.

10. A computer readable storage medium including computer readable instructions that when executed by a processor, cause the processor to:
establish a connection to a central server using a secure socket connection;
transmit an indication of a recipient address to the central server;
transmit data over the established connection to the central server, wherein the central server will forward the data to a recipient identified by the recipient address over a connection established by the recipient to the central server through a secure socket connection.

11. The computer readable storage medium of claim 10 further including computer readable instructions for wherein the central server includes a directory of recipients, and the central server selects a recipient based on the indication of a recipient address.

12. The computer readable storage medium of claim 10 further including computer readable instructions for wherein the connection from the recipient to the central server was established before the step of providing to the central server an indication of a recipient address.

13. The computer readable storage medium of claim 10 further including computer readable instructions for wherein the recipient establishes the connection to the central server in response to a message transmitted by the central server to the recipient.

14. The computer readable storage medium of claim 10 further including computer readable instructions for wherein the step of establishing a connection to a central server includes establishing a connection through a local firewall.

15. The computer readable storage medium of claim 10 further including computer readable instructions for wherein the step of establishing a connection to a central server includes the central server performing authentication before the central server establishes the connection.

16. The computer readable storage medium of claim 10 further including computer readable instructions for wherein the step of providing to the central server an indication of a recipient address includes utilizing a directory of recipient addresses maintained by the central server.

17. The computer readable storage medium of claim 16 further including computer readable instructions wherein the directory includes an indication for a recipient of information formats supported for transmitting information to the recipient.

18. The computer readable storage medium of claim 17 further including computer readable instructions for wherein the step of transmitting the information over the established connection to the central server includes receiving permission to transmit the information in a format indicated by the directory as supported for a recipient, wherein the information format was not previously available.

19. A method of connecting parties for allowing the transmission of information between the parties, the method comprising:
receiving a request to connect from a first party;
authenticating the first party, and accepting a data connection initiated by the first party using a secure socket connection of the first party;
receiving a request to connect from a second party;
authenticating the second party, and accepting a data connection initiated the second party using a secure socket connection of the second party;
receiving an indication from the first party to connect to the second party;
receiving information from the first party over the data connection with the first party, and transmitting the received information to the second party over the data connection with the second party.

20. The method of claim 19 further including:
providing a directory of recipients for use by the first party to assist the first party in indicating the second party to connect to.
